(19) United States
(12) Patent Application Publication
(10) Pub. No.: US 2012/0235340 A1
(43) Pub. Date: Sep. 20, 2012

(54) Portable Universal Power Station (PUPS)

(75) Inventor: Roger W. Jordan, Anthem, AZ (US)

(73) Assignee: Roger Wroy Jordan, Anthem, AZ (US)

(21) Appl. No.: 13/065,248

(22) Filed: Mar. 18, 2011

(51) Int. Cl. B25H 1/10

(52) U.S. Cl. 269/290

(57) ABSTRACT

PUPS is a portable stable folding cutting station that is designed for use with a variety of saws. You can make straight and mitered cuts with the guided rails that rotate on a fixed base plate.

### CROSS-REFERENCE TO RELATED APPLICATIONS

Not Applicable

### STATEMENT REGARDING FEDERALLY SPONSORED RESEARCH AND DEVELOPMENT

This invention has not been sponsored or associated with any Federally sponsored research and development program.

### REFERENCE TO SEQUENCE LISTING, A TABLE, OR A COMPUTER PROGRAM LISTING COMPACT DISK APPENDIX

Not Applicable

### BACKGROUND OF INVENTION

To provide a portable cutting station that can be used with universal power saws to make straight and miter cuts.

### BRIEF SUMMARY OF THE INVENTION

A portable free standing station that allows one to perform precise straight and miter cuts with most any hand held circular or jig power saws.

### BRIEF DESCRIPTION OF SEVERAL VIEWS OF THE DRAWING

FIG. 1 Top View Sketch

FIG. 2 Front/Rear View Sketch

FIG. 3 Side View Sketch

FIG. 4 Top View Photo

FIG. 5 Front/Rear View Photo

FIG. 6 Side View Photo

FIG. 7 Full View With Saw Photo

FIG. 8 Full Side View With Saw Photo

FIG. 9 Close-up Rear View With Saw Photo

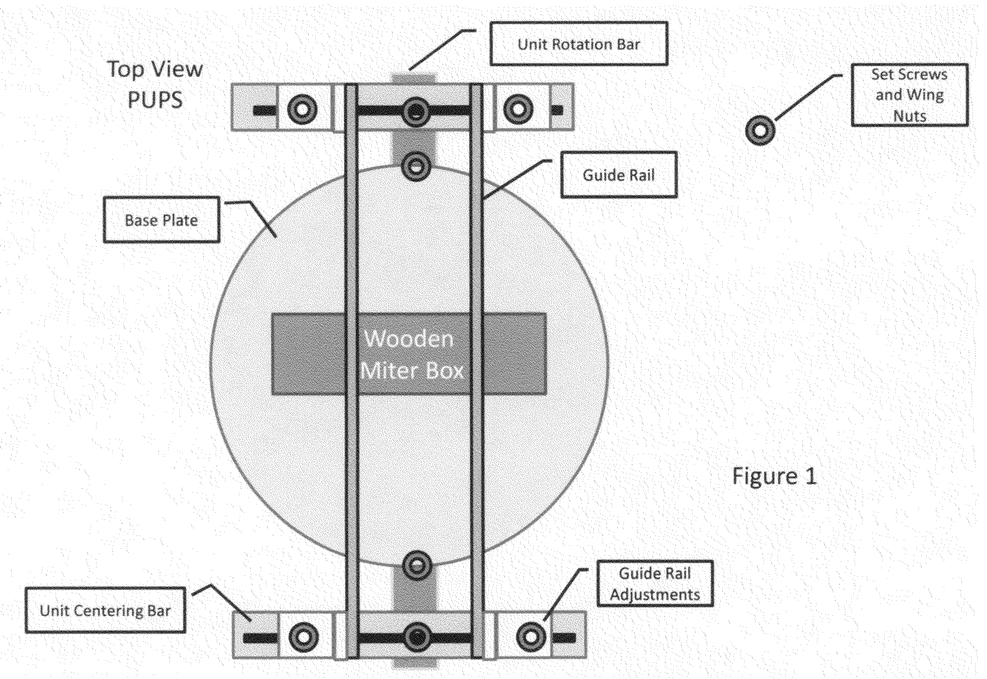

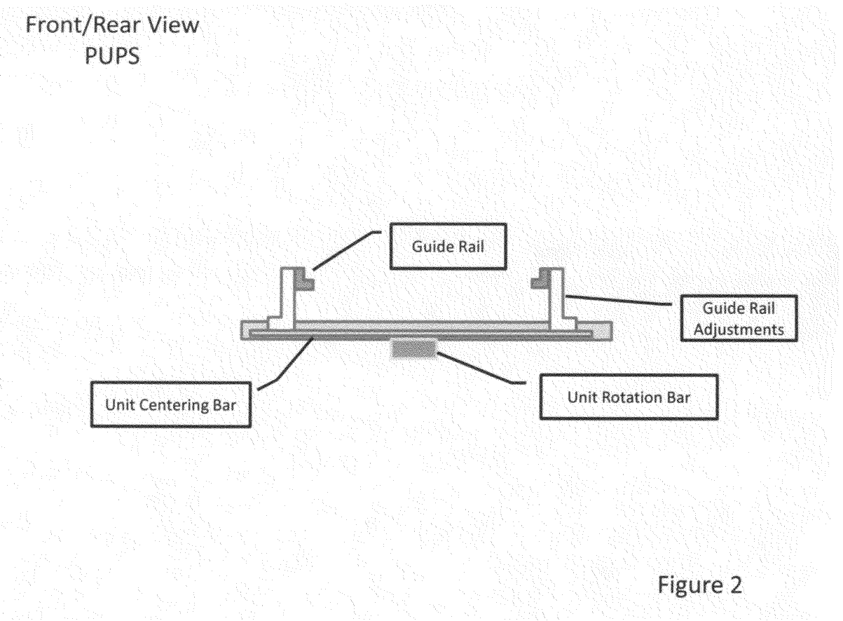

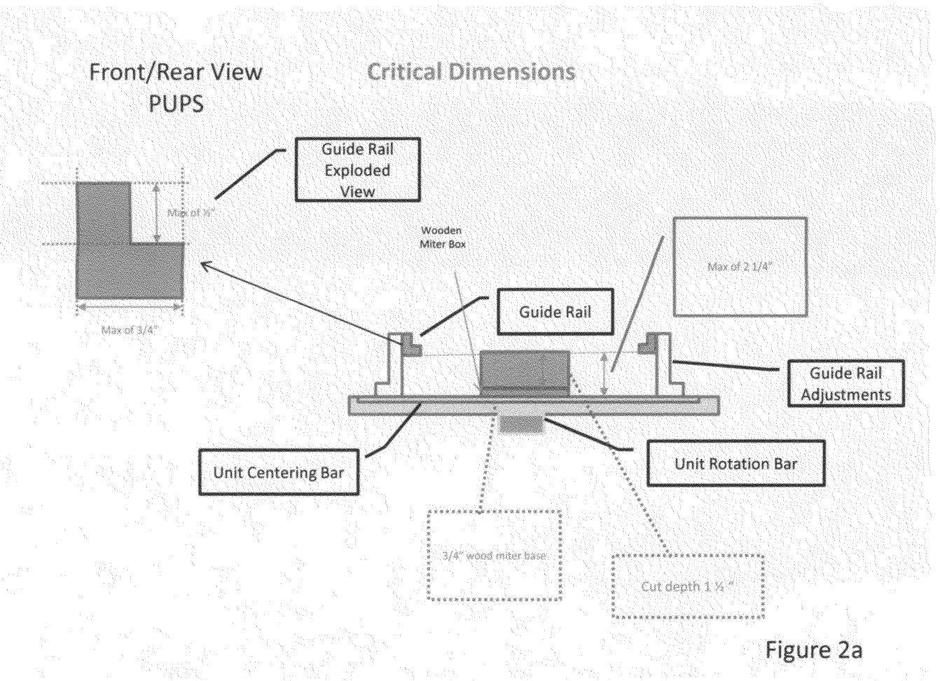

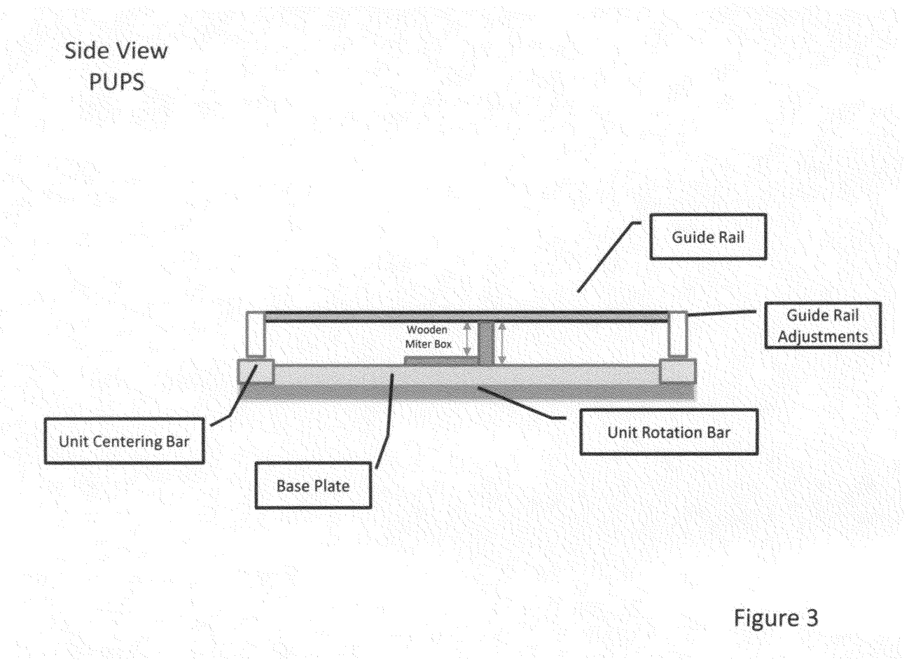

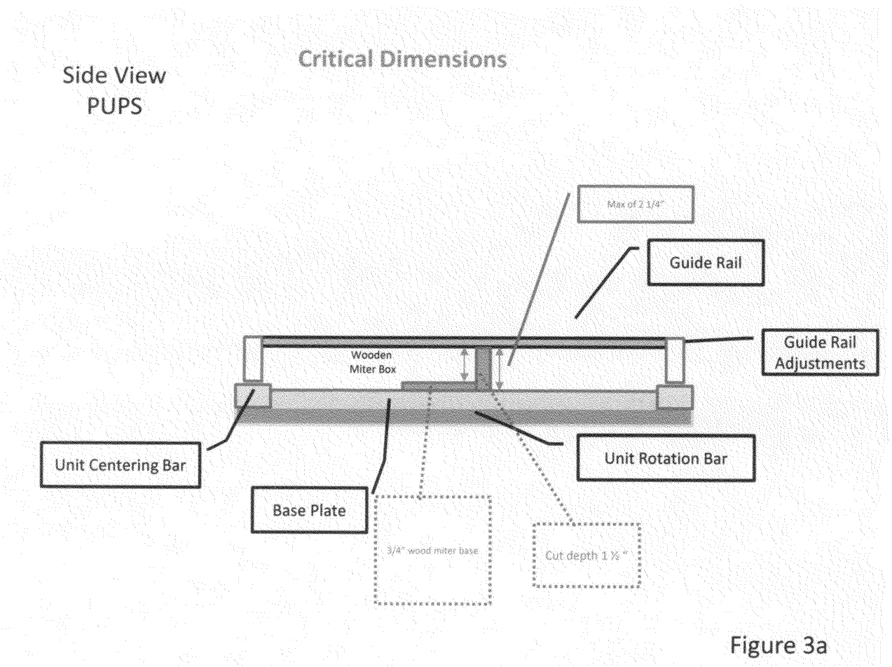

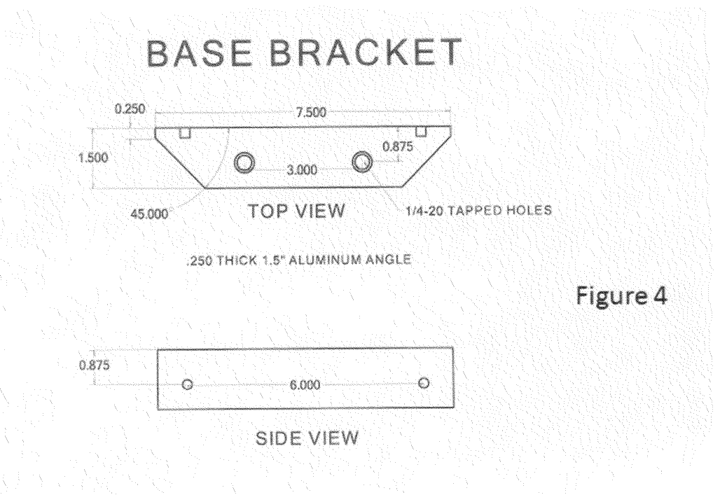

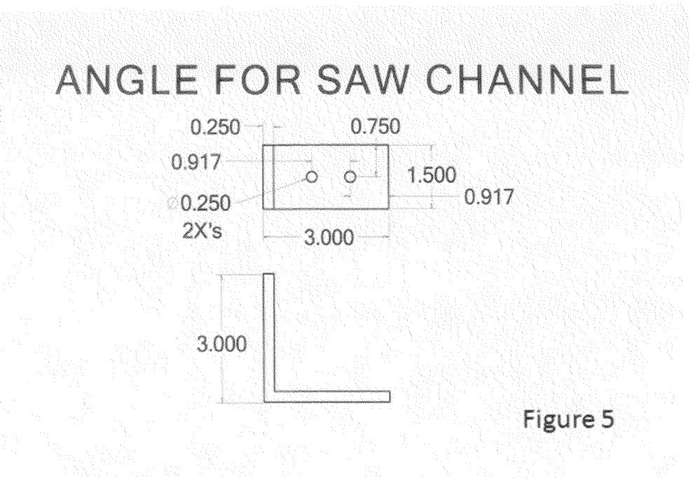

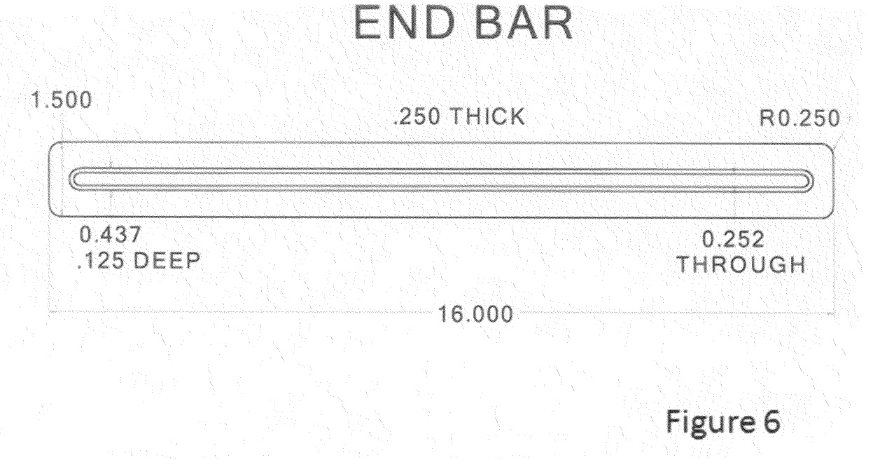

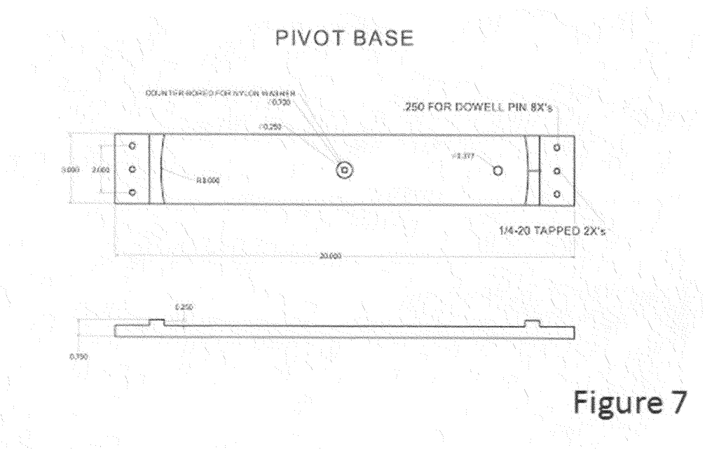

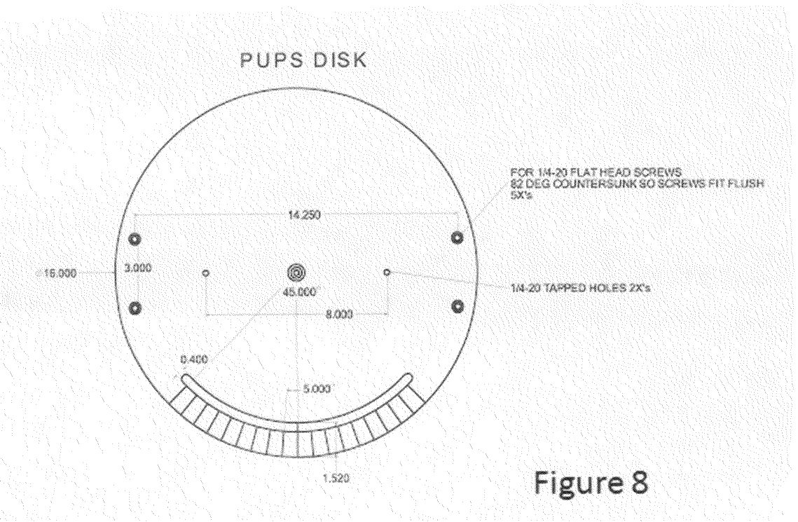

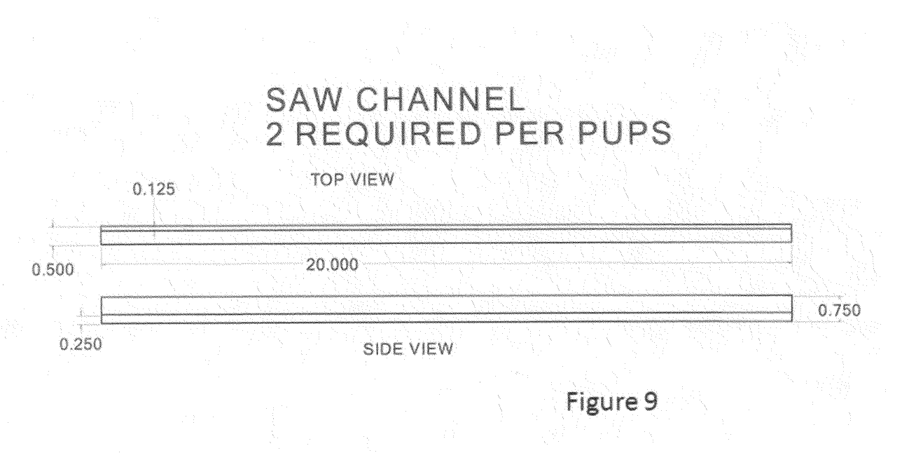

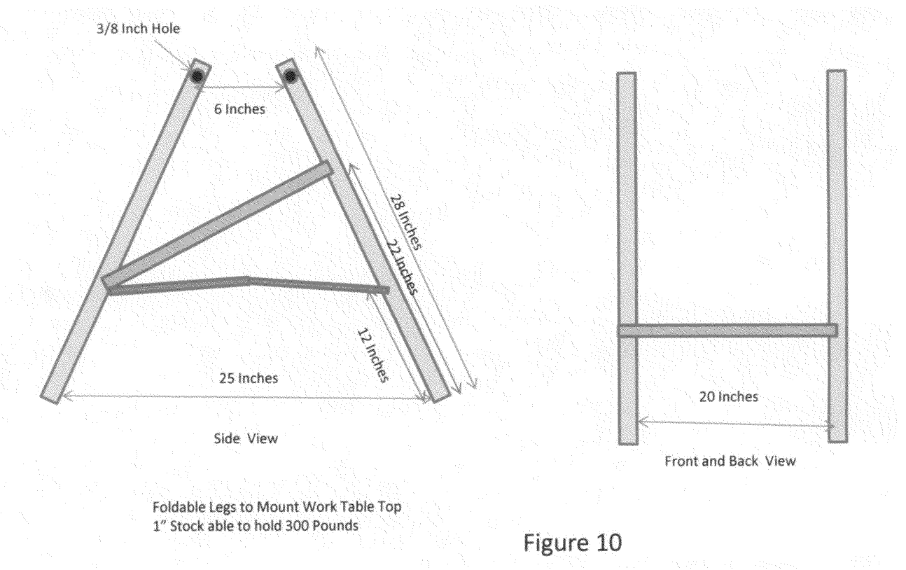

### DETAILED DESCRIPTION OF THE INVENTION

PUPS is a portable folding cutting station in which one can use their already pre-owned saws to make precise cuts either straight or mitered. The adjustable “guide rails” allow the use of different size circular saws, and can even be adjusted to fit a jig saw. Once the saw is in place you have a stable cutting surface to perform straight and mitered cuts. The rotating “guide rails” allows precise guided miter cuts.

1. A power station designed for straight and mitered cuts using virtually any circular or jig saw.
Contractors and “week-end do-it-yourselfers” can that advantage of this light weight portable stable cutting station. By using a variety of saws to perform straight cuts as well as miter cuts. The adjustable guide rails allow you to do this. No need to buy that expensive Miter saw/chop saw just use your skill saw you already have. You don't have to drag out the saw horses and the claps to do a few cuts. Just grab your saw and unfold your PUPS and you are ready to go.
